(19) United States
(12) Patent Application Publication
(10) Pub. No.: US 2024/0420424 A1
(43) Pub. Date: Dec. 19, 2024

(54) GRADIENT MESH GENERATION FOR DIGITAL IMAGES

(71) Applicant: Adobe Inc., San Jose, CA (US)

(72) Inventors: Jakub Fiser, Milton Keynes (GB); Niloy Jyoti Mitra, Potters Bar (GB); Koki Madono, Tokyo (JP)

(73) Assignee: Adobe Inc., San Jose, CA (US)

(21) Appl. No.: 18/209,934

(22) Filed: Jun. 14, 2023

(51) Int. Cl. G06T 17/20; G06T 19/20

(52) U.S. Cl. CPC G06T 17/205; G06T 19/20; G06T 2219/2004; G06T 2219/2012

(57) ABSTRACT

Gradient mesh generation and rendering techniques are described. In one or more implementations, a gradient mesh processing system leverages a vertex buffer and an index buffer. The vertex buffer is used to define vertexes and color values of respective patches in the geometry. The index buffer is then used to define which of the vertexes and corresponding color values are to be used to generate a respective patch. As a result, two or more vertexes are definable in the vertex buffer that share a location within the geometry but have different color values. The index buffer is therefore usable to select different collections of vertices from the vertex buffer to define a respective patch.

### BACKGROUND

Gradient meshes are usable to support the creation of complex color gradients in digital images. Gradient meshes, for instance, are employed to generate detailed images that recreate real-world scenes, such as a human face and changes in color and light on a surface of the human face caused by a respective environment. However, conventional techniques used to generate and render gradient meshes are challenged in some scenarios to produce accurate results. An example of which includes image vectorization in which a raster image is converted into a vector image. These challenges result in visual artifacts due to the inaccuracies, inefficient use of computational resources when attempting to correct the inaccuracies, and increased power consumption.

### SUMMARY

Gradient mesh generation and rendering techniques are described. In one or more implementations, a gradient mesh processing system leverages a vertex buffer and an index buffer. The vertex buffer is used to define vertexes and color values of respective patches in the geometry. The index buffer is then used to define which of the vertexes and corresponding color values are to be used to generate a respective patch. As a result, two or more vertexes are definable in the vertex buffer that share a location within the geometry but have different color values. The index buffer is therefore usable to select different collections of vertices from the vertex buffer to define a respective patch, which may share locations within a geometry but have different color values.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ gradient mesh generation and rendering techniques described herein.

FIG. 2 depicts a system in an example implementation showing operation of a gradient mesh processing system of FIG. 1 in greater detail as employed to vectorize a raster digital image to form a vector digital image by generating gradient meshes as depicting a geometry included in the raster digital image.

FIG. 3 depicts a system in an example implementation showing operation of a segmentation module of FIG. 2 in greater detail.

FIG. 4 depicts a system in an example implementation showing operation of a patch generation module of FIG. 2 in greater detail.

FIG. 5 depicts a system in an example implementation showing operation of a position correlation module of the mesh generation module of FIG. 2 in greater detail.

FIG. 6 depicts a system in an example implementation showing operation of the position correlation module of FIG. 5 in greater detail as employing a vertex buffer and an index buffer.

FIG. 7 depicts a system in an example implementation showing operation of an adjustment module of a post-processing module of FIG. 2 in greater detail.

FIG. 8 depicts a system in an example implementation showing operation of a color merging module of a post-processing module of FIG. 2 in greater detail.

FIG. 9 is a flow diagram depicting an algorithm as a step-by-step procedure in an example implementation of operations performable for accomplishing a result of gradient mesh generation and rendering.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

Image vectorization is a technique used in digital image processing in which a raster image formed using a plurality of pixels (e.g., as a bitmap) is converted into a vector image. The vector image is mathematically defined using geometric shapes, e.g., using gradient meshes. Vector images support scaling without loss in image quality, and thus are usable in an expanded range of digital image scenarios with increased visual accuracy.

Gradient meshes are formed using vertexes and color values. Vertexes are used to specify locations with respect to a geometry being defined (e.g., to depict an object) and color values are defined for the locations. The vertexes are then connected (e.g., using Bezier curves as straight or curved lines) to form a geometry, e.g., of the object being depicted. When rendering the gradient mesh, color values are interpolated between the vertexes based on the respective color values assigned to those vertexes to fill interiors of patches formed using the vertexes.

Conventional gradient mesh techniques, however, are challenged with accurately defining a “hard” color transition in a geometry. In defining a hard color transition using conventional techniques, for instance, an additional set of vertexes are typically added that are adjacent to each other in the mesh, which introduces a number of technical challenges. In a first such example, subsequent edits made to the color transition are confronted with an additional set of vertexes. In a second such example, stability challenges are introduced when conventional mesh optimization techniques are employed, e.g., relatively small and/or thin patches formed from the additional set of vertexes lead to color inaccuracies and degenerated behaviors such as flipping.

Conventional gradient techniques are also typically challenged when implementing smooth color transitions. This is because conventional techniques involving image tracing and vectorization typically employ segmentation to form solid colors for individual portions, e.g., different parts of the face.

Accordingly, gradient mesh generation and rendering techniques are described that address these technical challenges. In one or more implementations, color values used to define a gradient mesh are “detached” from vertexes used to define positions within a geometry defined by the mesh. To do so, a gradient mesh processing system leverages a vertex buffer and an index buffer. The vertex buffer includes, in one or more examples, vertexes and color values used to define respective patches in the geometry. The index buffer is then used to define which of the vertexes and corresponding color values are to be used to generate a respective patch.

In this way, two or more vertexes may be defined in the vertex buffer that share a location within the geometry but have different color values. The index buffer is therefore usable to select different collections of vertices from the vertex buffer to define a respective patch. As a result, patches that are adjacent to each other in the geometry support hard color transitions without introduction of additional adjacent vertexes as involved in conventional techniques, thereby improving visual accuracy, computational efficiency, and reducing power consumption.

A gradient mesh processing system, for instance, receives a raster digital image, e.g., formed as a bitmap. The gradient mesh processing system, in an implementation, then forms a plurality of segments (e.g., as “super pixels) from the digital image. A variety of techniques may be employed to form the segments, e.g., thresholding, edge-based segmentation, region-based segmentation, use of clustering techniques, machine-learning models, and so forth. The segments, for instance, may correspond to particular semantic portions of an object and/or an object as a whole. In an example of a human face, the segments are usable to represent eyes, nose, mouth, ears, and so on.

The segments are then used as a basis to form patches as respective single gradient meshes defined using initial vertexes and corresponding color values. The patches, for instance, are generated by the gradient mesh processing system based on variability of colors within the segments, e.g., to represent respective color values within a threshold amount.

The gradient mesh processing system then generates a gradient mesh based on the patches. To do so, the gradient mesh processing system generates vertexes and color values based on the respective patches. A vertex buffer is used to maintain the vertexes and color values. An index buffer is also used to index respective vertexes and color values that are to be used to generate a respective patch.

The vertex buffer, for instance, is configurable to define two vertices that share a location in a geometry to be generated but have different color values. The index buffer is therefore usable to select vertexes for respective patches that are adjacent to each other and use respective color values for those patches, e.g., as a vector object formed as representing the geometry from the raster digital image. In this way, hard and smooth color transitions are supported as part of rendering the patches with increased accuracy and computational efficiency (e.g., using fewer vertexes), which also reduces power consumption.

Consider an example in which two patches in the geometry of the digital image are adjacent to each other. The two patches, however, in this example correspond to different segments of the geometry and therefore exhibit a hard color transition between the patches. The transition, for instance, is exhibited from a patch included as part of a mouth of a human face to a patch included as part of a skin of the human face.

To support this transition, the index buffer is used to select vertexes from the vertex buffer that correspond to respective patches. Therefore, even though the vertexes may share a location with respect to the geometry, different color values are usable for the respective patches thereby supporting a hard color transition between the patches, which is not possible in conventional techniques. Post-processing techniques are also usable to increase accuracy and efficiency, such as color merging, adjustment of positions and/or color values associated with the vertexes in the vertex buffer, and so forth. Further description of these and other examples is included in the following discussion and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

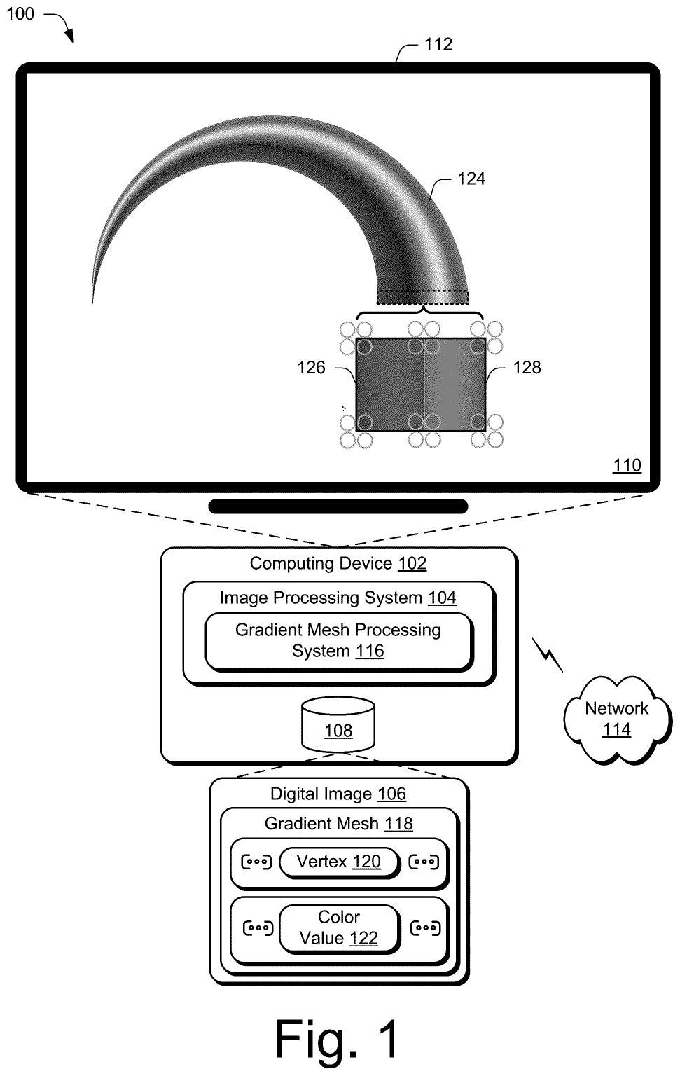

FIG. 1 is an illustration of a digital medium environment 100 in an example implementation that is operable to employ gradient mesh generation and rendering techniques described herein. The illustrated environment 100 includes a computing device 102, which is configurable in a variety of ways.

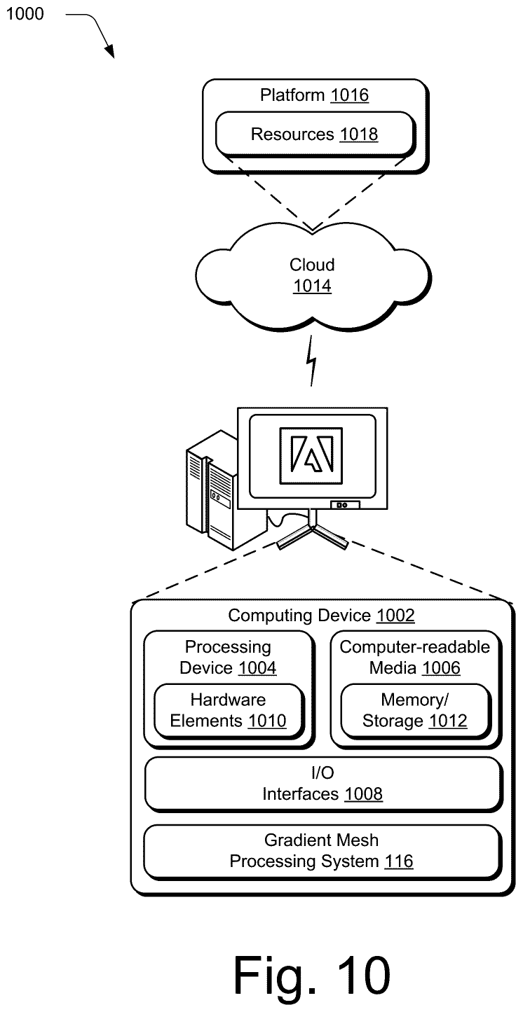

The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 10.

The computing device 102 is illustrated as including a image processing system 104. The image processing system 104 is implemented at least partially in hardware of the computing device 102 to process and transform digital image 106, which is illustrated as maintained in a storage device 108 of the computing device 102. Such processing includes creation of the digital image 106, modification of the digital image 106, and rendering of the digital image 106 in a user interface 110 for output, e.g., by a display device 112. Although illustrated as implemented locally at the computing device 102, functionality of the image processing system 104 is also configurable as whole or part via functionality available via the network 114, such as part of a web service or “in the cloud.”

An example of functionality incorporated by the image processing system 104 to process the digital image 106 is illustrated as a gradient mesh processing system 116. The gradient mesh processing system 116 is configured to generate a gradient mesh 118 used to define a geometry within a digital image 106, e.g., an object. To do so, the gradient mesh 118 is generated based on a plurality of vertexes 120 and color values 122. In this example, the color values 122 are “detached” from the vertexes 120 in that multiple color values may be used for a same location in a geometry being modeled by the gradient mesh 118 and as such expands beyond a conventional “one-to-one” mapping of vertex to color value as performed in conventional techniques.

In the illustrated example in the user interface 110, for instance, a geometry 124 defined as a raster object is to be converted to a gradient mesh 118 as part of defining a vector object. Accordingly, first and second patches 126, 128 are formed that are adjacent to each other. The first and second patches are defined via respective locations as vertexes of respective rectangles, two of which are shared. Each of the vertexes is illustrated as supporting four color values through respective circles disposed adjacent to the vertexes at the corners of the first and second patches 126, 128. Therefore, even though the first and second patches 126, 128 share a side that involves a color transition, color values used to define gradients within the respective patches are definable, separately, without addition of additional vertexes as involved in conventional techniques. In the following discussion, techniques to generate and render a gradient mesh 118 are described in greater detail.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Gradient Mesh Generation and Rendering

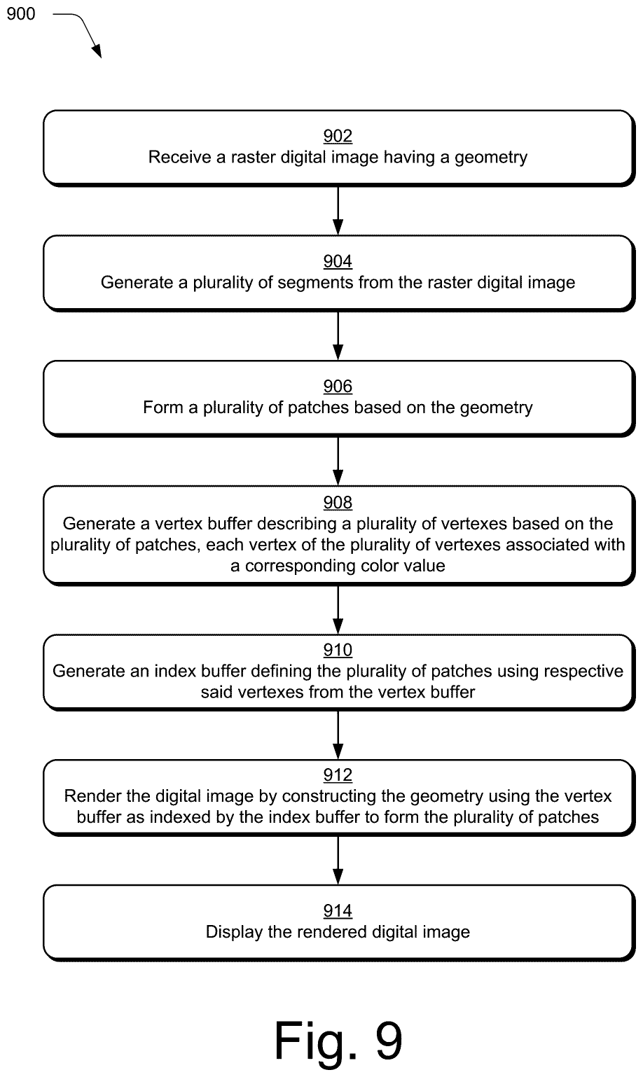

The following discussion describes gradient mesh generation and rendering techniques that are implementable utilizing the described systems and devices. Aspects of each of the procedures are implemented in hardware, firmware, software, or a combination thereof. The procedure is shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-8 in parallel with FIG. 9. FIG. 9 is a flow diagram depicting an algorithm 900 as a step-by-step procedure in an example implementation of operations performable for accomplishing a result of gradient mesh generation and rendering.

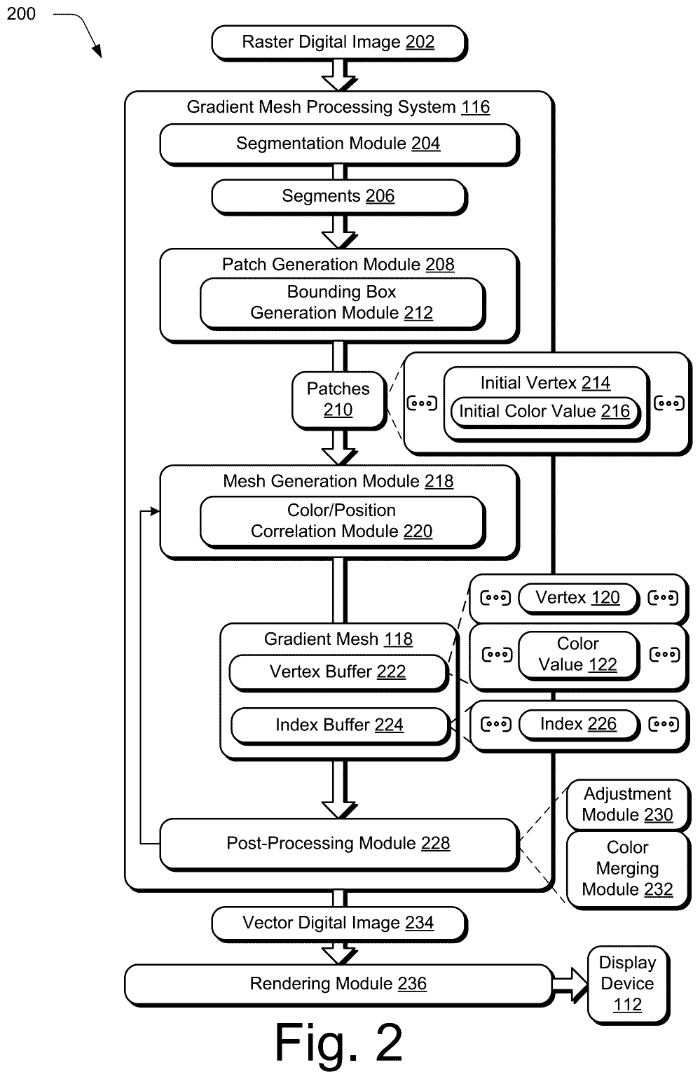

FIG. 2 depicts a system 200 in an example implementation showing operation of a gradient mesh processing system of FIG. 1 in greater detail as employed to vectorize a raster digital image to form a vector digital image by generating gradient meshes as depicting a geometry included in the raster digital image. To begin in this example, a raster digital image 202 is received by the gradient mesh processing system 116. The raster digital image 202 includes a geometry (block 902), e.g., of an object depicted in the raster digital image 202. The gradient mesh processing system 116 in this example is then tasked with converting the geometry into a vector object, e.g., to support scaling without encountering visual artifacts as would be observed in rescaling of the raster digital image 202. Other examples that employ generation and subsequent use of a gradient mesh are also contemplated.

The gradient mesh processing system 116 first employs, optionally, a segmentation module 204 to generate segments 206 based on the raster digital image 202 (block 904). The segments 206 act as a guide in this example to improve subsequent patch formation by first defining segments as semantically related collections of pixels.

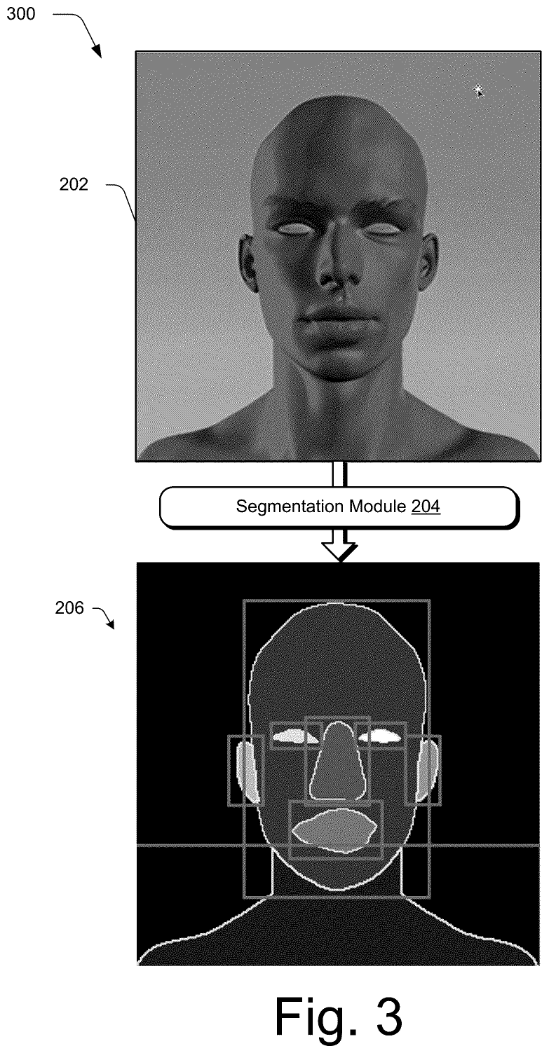

FIG. 3 depicts a system 300 in an example implementation showing operation of a segmentation module 204 of FIG. 2 in greater detail. The segmentation module 204 in this example receives the raster digital image 202 having a geometry that depicts a human face. The segmentation module 204 is then used to generate segments 206 as “super-pixels” that indicate a relationship of respective pixels to the geometry as a whole. The segments 206 formed of the human face, for instance, are used to define eye, ears, nose, and mouth of the human face. The segments 206 also include an indication of the human face as a whole as indicated by respective bounding boxes. The segmentation module 204 may employ a variety of different segmentation techniques to generate the segments 206.

In a first example, thresholding is utilized in which a threshold value is set and values of pixels are segmented based on a relationship of a value of the pixel to the threshold value, e.g., contrast, intensity, and so forth. In a second example, edge-based segmentation is employed by the segmentation module 204 to identify edges of objects within the raster digital image 202, such as due to changes in color or brightness between adjacent groups of pixels. In a region-based example, a pixel is selected as a seed and then regions are grown by including adjacent pixels that have the same or similar properties, such as grayscale level, color, texture, and so forth. Clustering examples may also be employed by the 204, such as a K-means clustering algorithm to group pixels having similar attributes. The segmentation module 204 may also utilize a machine-learning model (e.g., convolutional neural network or other deep-learning technique) that is trained as a classifier to assign tags (e.g., semantic tags) to respective pixels. A variety of other examples are also contemplated.

The segments are then passed by the segmentation module 204 as an input to a patch generation module 208 to generate patches 210 based on the geometry (block 906), e.g., the segments 206. A bounding box generation module 212, for instance, is utilized find a bounding box for each of the segments 206. The bounding boxes are then divided and sub-divided to form respective patches 210 defined using a respective initial vertex 214 and initial color value 216.

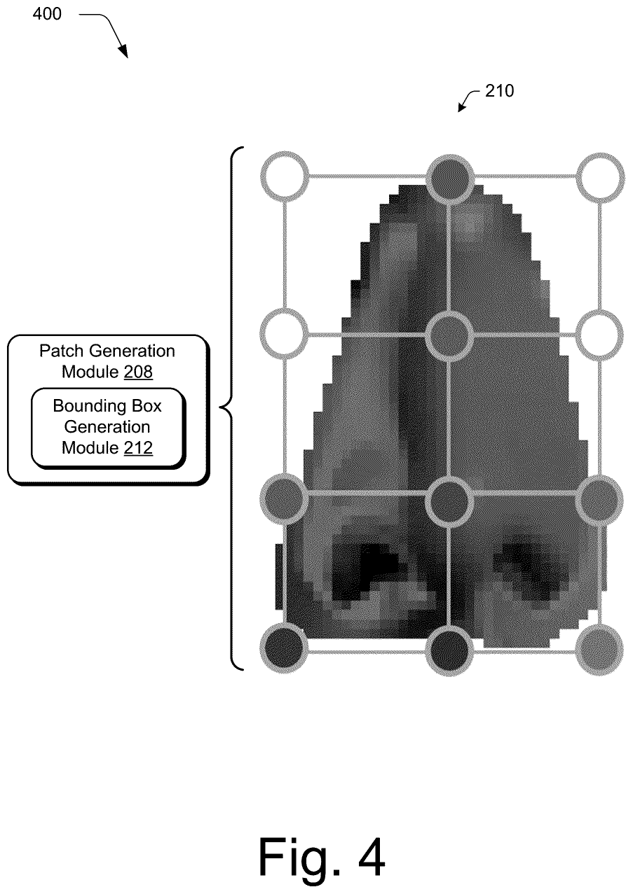

FIG. 4 depicts a system 400 in an example implementation showing operation of a patch generation module 208 of FIG. 2 in greater detail. The patch generation module 208 in this example is configured to generate patches 210 of a nose of the human face of FIG. 3. The bounding box generation module 212 is configured to generate a bounding box, which is then divided and subdivided to form the patches 210 as rectangles in this example.

The dividing and subdividing of the bounding boxes is performed by the bounding box generation module 212 based on a complexity of pixels in a respective bounding box, i.e., how variable values of the pixels are within the bounding box. Accordingly, bounding boxes are divided and subdivided in this example by the bounding box generation module 212 until the complexity is lower than a predefined threshold, e.g., which defines suitability for forming a gradient mesh. Each of the patches is then defined using initial vertexes 214 and initial color values 216 which are illustrated as circles at respective location within the geometry of FIG. 4. As a result, a smaller number of patches are formed from the bounding boxes for segments 206 that have smoother values.

The patches 210 are then passed as an input to a mesh generation module 218 that is configured to generate a gradient mesh 118. The mesh generation module 218, for instance, is configurable to generate a gradient mesh 118 for each of the patches 210.

To do so, a color/position correlation module 220 is employed to generate a vertex 120 and color values 122 for respective patches 210. The color/position correlation module 220, for instance, is configured to generate a vertex buffer 222 (block 908) having vertex 120 and color values 122 based on the initial vertex 214 and initial color values 216 of the patches 210. Accordingly, the vertex buffer describes a plurality of vertexes 120 based on the plurality of patches 210, each vertex of the plurality of vertexes 120 is associated with a corresponding color value 122.

The color/position correlation module 220 is also configured to generate an index buffer 224 (block 910). The index buffer 224 defines the plurality of patches using indexes 226 into respective vertexes of the vertex buffer 222. The vertex buffer 22, for instance, may include a plurality of vertexes and respective color values as generated for each of the patches 210. In another example, the vertex buffer 222 is configured to maintain the vertexes 120 and associated color values for the vertexes 120 separately. Both of these examples overcome challenges and inaccuracies of conventional techniques as described in the following example and shown in a corresponding figure.

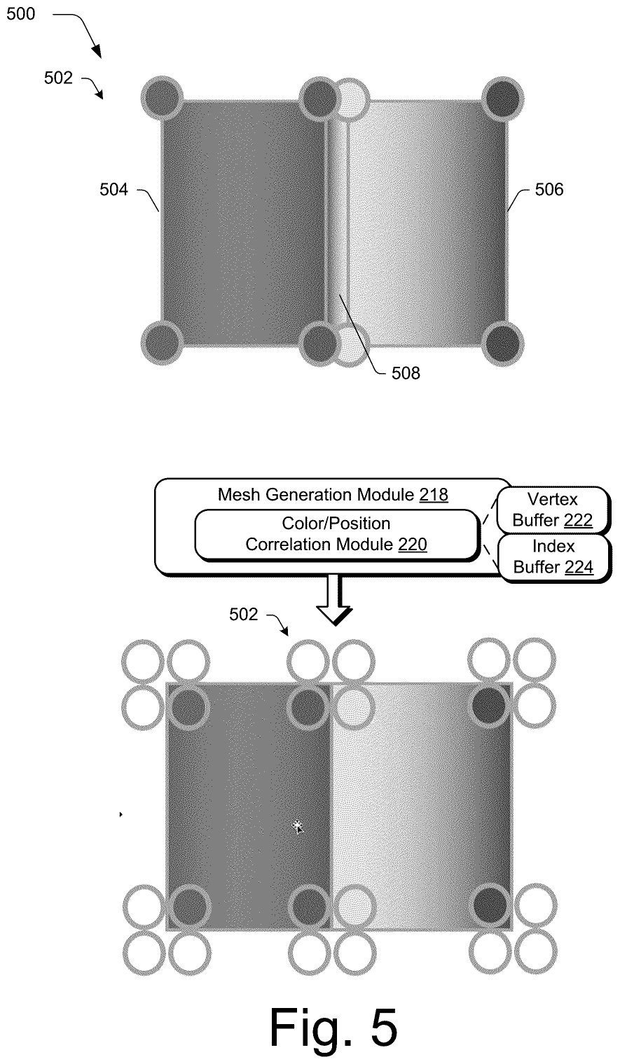

FIG. 5 depicts a system 500 in an example implementation showing operation of a position correlation module 220 of the mesh generation module 218 of FIG. 2 in greater detail. In a conventional example 502, a first and second patch 504, 506 is formed. In order to support a hard color transition a third patch 508 is added, e.g., manually through interaction with a user interface to add additional vertexes. As previously described, subsequent edits made to the color transition are therefore confronted with an additional set of vertexes. Stability challenges are also introduced when conventional mesh optimization techniques are employed, e.g., relatively small and/or thin patches formed from the additional set of vertexes lead to color inaccuracies and degenerated behaviors such as flipping.

However, the techniques described herein support assignment of two or more color values to a respective location within a geometry. The position correlation module 220, for instance, is configurable to define a vertex buffer 222 having a vertex 120 and corresponding color value 122 for each of the patches, which may be optimized through color merging and adjustments as further described below. The index buffer 224 is then used to define patches 210 for rendering as indexes 226 to particular vertexes 120 and corresponding color values 122 that are to be used to form the patch. Other examples are also contemplated in which the vertexes and color values are maintained separately with the vertex buffer, e.g., such that an individual vertex may be associated with a plurality of color values which are also indexed by the index buffer 224 for use in forming the patches 210.

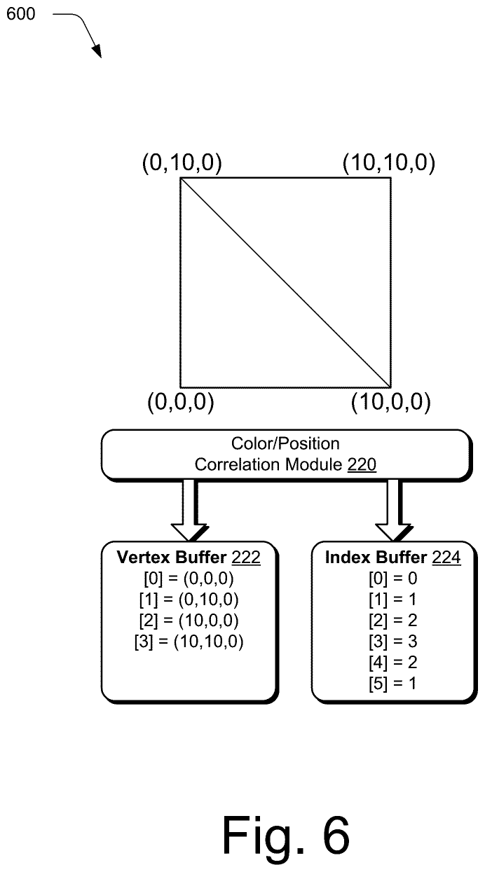

FIG. 6 depicts a system 600 in an example implementation showing operation of the position correlation module 220 of FIG. 5 in greater detail as employing a vertex buffer 222 and an index buffer 224. The vertex buffer 222 in this example is formed as an array of vertexes, and more particularly coordinates of the locations of the vertexes. The index buffer 224 is an additional array that specifies which vertexes from the vertex buffer 222 are to be used to construct a respective patch, which are triangles in this example.

Color values may also be included in a variety of ways as part of the vertex buffer 222. In one example as described above, the color values are included as an additional entry along with tuple of the coordinates used to define the position of the vertex. In an additional example, an additional color buffer is utilized along with the vertexes in the vertex buffer. In this additional example, therefore, the index buffer 224 references the vertexes and the color values from the vertexes and the color values maintained separately in the vertex buffer 222. A variety of other examples are also contemplated.

Returning again to FIG. 2, the gradient mesh processing system 116 may also employ a post-processing module 228 that is configured to post-processes the gradient mesh 118, e.g., to increase efficiency, image accuracy, and so forth. Examples to do so are represented as an adjustment module 230 and a color merging module 232.

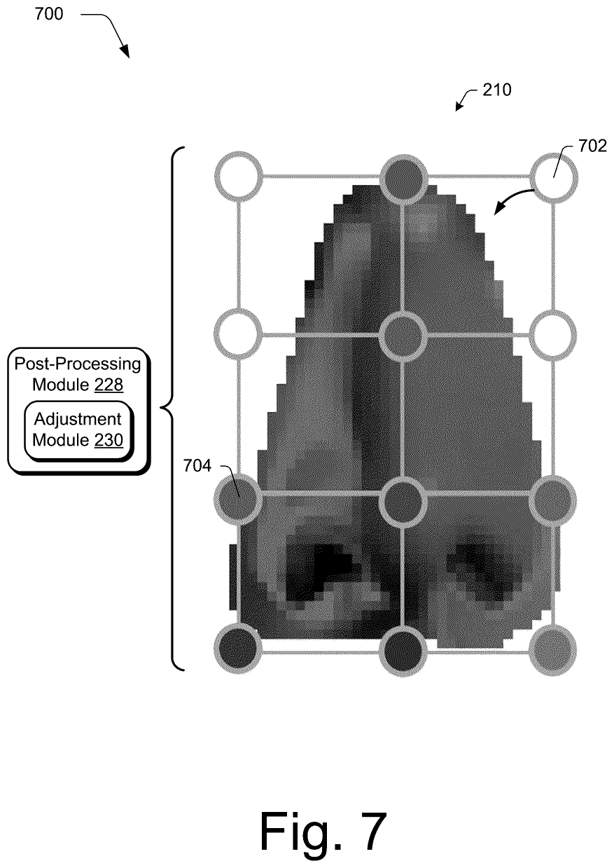

FIG. 7 depicts a system 700 in an example implementation showing operation of an adjustment module 230 of the post-processing module 228 of FIG. 2 in greater detail. The adjustment module 230 is this example is configured to adjust values of the gradient mesh 118 in order to increase appearance accuracy. To do so, the adjustment module 230 makes adjustments to the values (e.g., over one or more iterations) and compares a result of the adjustments to the raster digital image 202. As a result, the adjustment module 230 is able to improve accuracy of the gradient mesh 118 in modeling the raster digital image 202.

In a first example, the adjustment module 230 adjusts a location of a vertex 702 in the vertex buffer 222, e.g., to improve accuracy of a gradient used by a respective patch to recreate a corresponding portion of the raster digital image 202. In a second example, the adjustment module 230 adjusts a color value of a vertex 704 in the vertex buffer 222, e.g., such that colors of the gradient accurately reflect colors exhibited by a corresponding portion of the raster digital image 202. A variety of other examples are also contemplated, an example of which includes color merging as further described in the following discussion and shown in a corresponding figure.

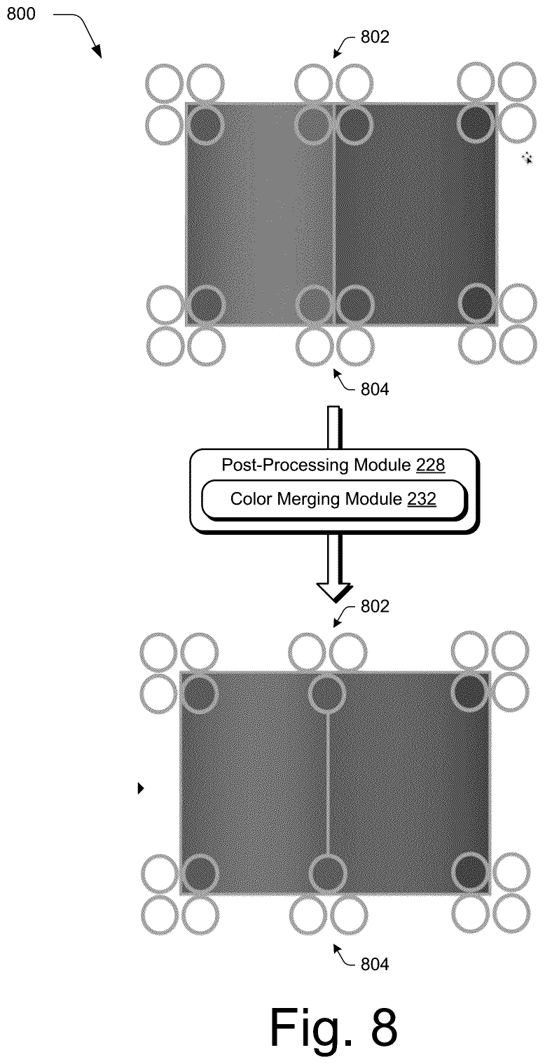

FIG. 8 depicts a system 800 in an example implementation showing operation of a color merging module 232 of the post-processing module 228 of FIG. 2 in greater detail. In this example, two patches share a common edge, defined using two shared vertexes 802, 804, each of which is depicted as having four associated color values for respective patches as represented by four circles and associated colors for each of the vertexes.

The color merging module 232 in this example determines that two of the values associated with the respective vertex are within a threshold amount of similarity, i.e., have color values within a threshold amount. The color merging module 232 therefore merges the color values to arrive at three color values as illustrated using respective three circles for each of the vertexes 802, 804. The color merging module 232 may do so by selecting one of the color values, averaging the color values, and so on. In this way, operation efficiency may be improved through use of a fewer number of color values, support a smoother transition between the patches, and so on. A variety of other post processing optimization are also contemplated.

Returning again to FIG. 2, the gradient mesh 118 is then output by the gradient mesh processing system 116 as converting the raster digital image 202 into a vector digital image 234. The vector digital image 234 is then rendered by a rendering module 236 by constructing the geometry using the vertex buffer 222 as indexed by the index buffer 224 to form the plurality of patches 210 (block 912). The rendered digital image is then displayed (block 914), e.g., in a user interface 110 by a display device 112.

### Example System and Device

FIG. 10 illustrates an example system generally at 1000 that includes an example computing device 1002 that is representative of one or more computing systems and/or devices that implement the various techniques described herein. This is illustrated through inclusion of the gradient mesh processing system 116. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a raster digital image having a geometry;
forming, by the processing device, a plurality of patches based on the geometry;
generating, by the processing device, a vertex buffer describing a plurality of vertexes based on the plurality of patches, each vertex of the plurality of vertexes associated with a corresponding color value;
generating, by the processing device, an index buffer defining the plurality of patches using respective said vertexes from the vertex buffer; and
rendering, by the processing device, the digital image by constructing the geometry using the vertex buffer as indexed by the index buffer to form the plurality of patches.

2. The method as described in claim 1, wherein index buffer references a first said patch having a first said vertex from the plurality of vertexes that shares a location with a second said vertex from the plurality of vertexes with a second said patch.

3. The method as described in claim 2, wherein the first said vertex has a first said color value that is different than a second said color value of the second said vertex.

4. The method as described in claim 1, wherein the vertex buffer references at least two said vertexes that share a position.

5. The method as described in claim 1, further comprising generating a plurality of segments from the raster digital image and wherein the forming the plurality of patches is based on the plurality of segments.

6. The method as described in claim 1, wherein the generating the index buffer includes combining a first said vertex and a second said vertex that share a location in the geometry and a color value.

7. The method as described in claim 1, wherein the generating the index buffer includes adjusting at least one vertex in the index buffer.

8. The method as described in claim 7, wherein the adjusting includes adjusting a location of the at least one said vertex and comparing a result of the adjusting with the digital image.

9. The method as described in claim 7, wherein the adjusting includes adjusting a color value of the at least one said vertex and comparing a result of the adjusting with the digital image.

10. The method as described in claim 9, wherein the adjusting causes a merging of the at least one said vertex and another said vertex of the vertex buffer as a single said vertex having a color value based on a color value of the at least one said vertex and a color value of the another said vertex.

11. The method as described in claim 1, wherein the rendering includes rendering a gradient of color values for a respective said patch based on color values defined for respective said vertexes from the vertex buffer as indexed by the index buffer.

12. A system comprising:
a mesh initialization module implemented by a processing device to generate a plurality of patches based on a geometry of a digital image;
a mesh generation module implemented by the processing device to generate a gradient mesh based on the plurality of patches, the gradient mesh having a plurality of vertexes and a plurality of color values, at least two said vertexes sharing a location in the geometry; and
a rendering module implemented by the processing device to render the gradient mesh.

13. The system as described in claim 12, wherein a first said vertex of the least two said vertexes has a first said color value that is different than a second said color value of a second said vertex of the at least two said vertexes that share the location in the geometry.

14. The system as described in claim 12, wherein the mesh generation module is configured to generate:
a vertex buffer including the plurality of vertexes and the plurality of color values; and
an index buffer defining the plurality of patches using respective said vertexes from the vertex buffer.

15. The system as described in claim 12, further comprising a post-processing module configured to adjust at least one vertex.

16. The system as described in claim 15, wherein the post-processing module is configured to:
adjust a location of the at least one said vertex and compare a result of the adjusting with the digital image; or
adjust a color value of the at least one said vertex and comparing a result of the adjusting with the digital image.

17. The system as described in claim 12, further comprising a post-processing module configured to merge at least one said vertex and another said vertex as a single said vertex having a color value based on a color value of the at least one said vertex and a color value of the another said vertex.

18. A computing device comprising:
a processing device; and
a computer-readable storage medium storing instructions that, responsive to execution by the processing device, causes the processing device to perform operations including:
receiving a digital image having a geometry defined using:
a vertex buffer describing a plurality of vertexes, each vertex of the plurality of vertexes associated with a corresponding color value; and
an index buffer defining a plurality of patches using respective said vertexes from the vertex buffer; and
rendering the digital image by constructing the geometry using the vertex buffer as indexed by the index buffer to form the plurality of patches.

19. The computing device as described in claim 18, wherein the rendering includes rendering a gradient of color values for a respective said patch based on color values defined for respective said vertexes from the vertex buffer as indexed by the index buffer.

20. The computing device as described in claim 18, wherein at least two said vertexes share a location within the geometry.
